(19) United States
(12) Patent Application Publication
(10) Pub. No.: US 2023/0217932 A1
(43) Pub. Date: Jul. 13, 2023

(54) FUNCTIONAL MICROBIAL-DERIVED PREPARATIONS

(71) Applicant: George W. Jackson, Pearland, TX (US)

(72) Inventor: George W. Jackson, Pearland, TX (US)

(21) Appl. No.: 18/153,139

(22) Filed: Jan. 11, 2023

Related U.S. Application Data
(60) Provisional application No. 63/298,333, filed on Jan. 11, 2022.

(51) Int. Cl. A01N 65/03; A01N 63/20; A01N 63/00; A01P 1/00; A01P 3/00

(52) U.S. Cl. CPC A01N 65/03; A01N 63/00; A01N 63/20; A01P 1/00; A01P 3/00

(57) ABSTRACT

This invention relates generally to methods of preparing compositions from microorganisms such as cyanobacteria, particularly to preparing compositions with antifungal and/or antibacterial characteristics, and more particularly to preparing cyanobacteria or other microorganism-derived compositions for use in construction materials. Cyanobacteria make various kinds of natural products that may be useful for a variety of applications, including products with antifungal and/or antibacterial activity, and other biologically active compounds (e.g. immunomodulatory, antitumor, antithrombotic, anticoagulant, anti-mutagenic, anti-inflammatory, antimicrobial, and antiviral). Some of the especially useful ones might be antifungals and antibacterials, such as by incorporation or application onto construction materials (e.g. drywall).

### CROSS-REFERENCE TO RELATED APPLICATIONS

This application claims the benefit and priority of U.S. provisional Pat. application Ser. No. 63/298,333, filed Jan. 11, 2022, the contents of which is hereby incorporated by reference in its entirety.

### FIELD OF THE INVENTION

This invention relates generally to methods of preparing compositions from microorganisms such as cyanobacteria, particularly to preparing compositions with antifungal and/or antibacterial characteristics, and more particularly to preparing cyanobacteria or other microorganism-derived compositions for use in construction materials.

### BACKGROUND OF THE INVENTION

Cyanobacteria make various kinds of natural products that may be useful for a variety of applications, including products with antifungal and/or antibacterial activity, and other biologically active compounds (e.g. immunomodulatory, antitumor, antithrombotic, anticoagulant, anti-mutagenic, anti-inflammatory, antimicrobial, and antiviral). Some of the especially useful ones might be antifungals and antibacterials. Cyanobacteria can often be grown with minimal nutrient expense or “farmed” in ponds naturally affected by eutrophication.

Further background on cyanobacteria and their uses can be found in:

Cyanobacteria, Wikipedia. (2019). https://en.wikipedia.org/w/index.php?title=Cyanobacteria&oldid=900186606 (accessed Jun. 11, 2019).

C. Halfmann, L. Gu, W. Gibbons, R. Zhou, Genetically engineering cyanobacteria to convert CO₂, water, and light into the long-chain hydrocarbon farnesene, Appl. Microbiol. Biotechnol. 98 (2014) 9869-9877. doi: 10.1007/s00253-014-6118-4.

M.M. de Souza, L. Prietto, A.C. Ribeiro, T.D. de Souza, E. Badiale-Furlong, Assessment of the antifungal activity of Spirulina platensis phenolic extract against Aspergillus flavus, Ciênc. E Agrotecnologia. 35 (2011) 1050-1058. doi: 10.1590/S1413-70542011000600003.

V.-N. Tariq, Antifungal activity in crude extracts of marine red algae, Mycol. Res. 95 (1991) 1433-1435. doi: 10.1016/S0953-7562(09)80398-5.

J.L. Morales, Z.O. Cantillo-Ciau, I. Sánchez-Molina, G.J. Mena-Rejón, Screening of Antibacterial and Antifungal Activities of Six Marine Macroalgae from Coasts of Yucatán Peninsula, Pharm. Biol. 44 (2006) 632-635. doi:10.1080/13880200600897569.

S. Mickymaray, W. Alturaiki, Antifungal Efficacy of Marine Macroalgae against Fungal Isolates from Bronchial Asthmatic Cases, Molecules. 23 (2018). doi:10.3390/molecules23113032.

G. Lopes, P.B. Andrade, P. Valentão, Screening of a Marine Algal Extract for Antifungal Activities, Methods Mol. Biol. Clifton NJ. 1308 (2015) 411-420. doi:10.1007/978-1-4939-2684-8_26.

Stachybotrys chartarum, Wikipedia. (2019). https://en.wikipedia.org/w/index.php?title=Stachybotrys_chartarum&oldid=896978578 (accessed Jun. 11, 2019).

### SUMMARY OF THE INVENTION

This invention relates generally to methods of preparing compositions from microorganisms such as cyanobacteria, particularly to preparing compositions with antifungal and/or antibacterial characteristics, and more particularly to preparing cyanobacteria or other microorganism-derived compositions for use in construction materials.

The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

In one aspect of the invention, a method for preparing a composition may generally include selection of one or more microbial species, screening them for a desired functional activity or trait and including the microbial species or a derived product therefrom in a material, such as construction material. In some embodiments of the invention, the microbial species may generally be selected from cyanobacteria species (“cyanos”) or other useful microbial species (e.g. various phytoplankton such as dinoflagellates and diatoms). The selected species may be harvested from an appropriate source, such as from bodies of water that experience eutrophication, or from a commercial source. They may then be cultured under appropriate growing conditions, such as in bioreactors, other cell culture, and/or by farming in bodies of water affected by eutrophication. Cyanos and phytoplankton may be desirable for culturing due to low input nutrient requirements and the general ability to grow in a wide variety of environments with minimal human intervention. The cultured microbes may then be harvested for use in screening for desired functional activity or traits, such as, for example, antifungal or antibacterial activity.

In some embodiments, the live microbes may be exposed to fungal and/or bacterial samples to screen for activity, such as the observed death, reduction, inhibition or other forms of suppressive activity of the fungal and/or bacterial samples by the microbes. In other embodiments, inactivated microbes (e.g. by heat inactivation, chemical inactivation, radiation inactivation, etc.) may be utilized for screening. In yet other embodiments, extracts or separated/purified products from the microbes may be utilized for screening. Candidates that show the desired activity or function may then be selected for use in a composition, such as by applying an inactivated form of the microbes or an extract (e.g. crude extract from a bulk culture, purified or separated constituents, etc.) to a construction material. For example, the microbial preparation may be applied to or mixed into another material, such as in drywall (or a portion thereof such as the gypsum component) by impregnating, painting/rolling on, spraying, soaking or any other appropriate application or incorporation method. This may be desirable to prevent fungal or bacterial growth on such material. In particular, drywall may generally be susceptible to the occurrence and damaging effects of molds and other contaminating organisms when exposed to moisture or humid environments that occur commonly, and such prepared drywall material may be better able to resist such organisms (e.g. a particularly important mold to inhibit may include Stachybotrys chartarum).

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, or feature, while functionally limited to traversing). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention, while maintaining its use to the indication of traversing.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

1. A method for utilizing functional activity of microbes comprising:
selecting at least one species of microbe;
culturing said at least one species of microbe under appropriate conditions for growth;
harvesting said at least one species of microbe;
applying at least a portion of said at least one species of microbe to a sample containing a contaminating organism;
detecting activity against said contaminating organism; and
including a preparation derived from said at least one species of microbe to a construction material.

2. The method of claim 1, wherein said at least one species of microbe is selected from the group consisting of cyanobacteria, dinoflagellates and diatoms.

3. The method of claim 1, wherein said appropriate conditions for growth comprises a body of water under eutrophic conditions.

4. The method of claim 1, wherein said contaminating organism comprises at least one of a fungal or bacterial species that contaminates said construction material when used.

5. The method of claim 4, wherein said contaminating organism comprises Stachybotrys chartarum.

6. The method of claim 1, wherein said activity against said contaminating organism comprises inhibition, reduction, bacteriocidal or fungicidal activity.

7. The method of claim 1, wherein said construction material comprises drywall or a portion thereof.

8. The method of claim 1, wherein said preparation comprises a crude extract, purified portion, separated or fractional portion, inactivated culture or a combination thereof.
